(19) United States
(12) Patent Application Publication
(10) Pub. No.: US 2022/0195250 A1
(43) Pub. Date: Jun. 23, 2022

(54) DAMPING MATERIAL AND DAMPING SHEET MADE THEREFROM

(71) Applicant: 3M INNOVATIVE PROPERTIES COMPANY, St. Paul, MN (US)

(72) Inventors: Jing Qiang HOU, Shanghai (CN); Kun WANG, Shanghai (CN); Qiong Juan DUAN, Shanghai (CN); Yao LI, Shanghai (CN); Yong JIANG, Shanghai (CN); Yinjie ZHOU, Shanghai (CN); Qingrui PENG, Shanghai (CN)

(21) Appl. No.: 17/432,295

(22) PCT Filed: Feb. 25, 2020
(86) PCT No.: PCT/IB2020/051600

§ 371 Date: Aug. 19, 2021

(30) Foreign Application Priority Data
Feb. 25, 2019 (CN) 201910139769.4

(51) Int. Cl. C09J 7/26; C09J 7/24; C09J 7/25; C09J 7/38; C09J 11/04; C09J 11/08; C09J 11/06

(52) U.S. Cl. CPC C09J 7/26; C09J 2400/166; C09J 7/255; C09J 7/38; C09J 11/04; C09J 11/08; C09J 11/06; C09J 2301/41; C09J 2301/302; C09J 2400/243; C09J 2425/006; C09J 2467/006; C09J 2453/006; C09J 2423/046; C09J 7/243

(57) ABSTRACT

The present invention provides a damping material and a damping sheet made therefrom. Specifically, the present invention provides a damping material comprising 10-50 wt % of a block copolymer elastomer; 5-40 wt % of a specific-length fiber; 5-45 wt % of a thermoplastic non-elastomeric polymer; 5-50 wt % of a tackifier; 0-50 wt % of an inorganic filler; and 0-30 wt % of a flame retardant based on the total weight of the damping material. The damping material and the damping sheet made therefrom according to the present invention have high damping properties, a wide application temperature range and a low density, and can serve as a novel damping material in the current automobile, rail transit, construction and electrical appliance industries.

### TECHNICAL FIELD

The present invention relates to the technical field of damping, and specifically to a damping material and a damping sheet made therefrom.

### BACKGROUND

Damping materials are widely implemented in the automobile, rail transit, aeronautics, astronautics, construction, and electrical appliance industries that are relevant in one's daily life. The operating principle of damping materials is based on their own viscoelasticity, wherein external mechanical energy can be converted into materials having internal friction and molecular motion as energy to be used.

Advanced materials and technologies are now being widely adopted by the automobile and rail transit industries to improve energy efficiency, decrease emission levels, and enhance the dynamic running performance of vehicles. Moreover, in the automobile and rail transit industries, damping has become increasingly important for improving vibration and noise control, dynamic stability, as well as fatigue and impact resistance.

At present, a large number of damping materials are used in the automobile, electrical appliance, and rail transit industries. Asphalt, butyl rubber, and LASD (liquid-applied sound damper) are the three most commonly used damping material types. However, asphalt has high density, poor damping properties, and further contains an excessive amount of carcinogenic polycyclic aromatic hydrocarbons that will cause health problems. Therefore, in the automobile industry, replacing asphalt damping materials and making vehicles lightweight both constitute a major trend. Although the damping properties of butyl rubber are favorable, it has poor heat resistance and suffers from excess flow when used, thereby having a narrow application range.

When used, LASD is highly automated, but it has average damping properties, requires high costs, and is quite limited in terms of the application range.

Therefore, developing a damping material having high damping properties, a low density, and a wide application range has great significance in the technical field.

### SUMMARY

Based on the technical problems described above, one of the objects of the present invention is to provide a damping material and a damping sheet made therefrom having high damping properties, a wide application temperature range, and a low density.

After intensive and detailed research, the present inventors have completed the present invention.

According to one aspect of the present invention, there is provided a damping material comprising, based on the total weight thereof, the following:

10-50 wt % of a block copolymer elastomer;

5-40 wt % of fiber;

5-45 wt % of a thermoplastic non-elastomeric polymer;

5-50 wt % of a tackifier;

0-50 wt % of an inorganic filler; and

0-30 wt % of a flame retardant.

According to some preferred embodiments of the present invention, the elastic modulus of the block copolymer elastomer is less than or equal to 500 MPa.

According to some preferred embodiments of the present invention, the weight-average molecular weight of the block copolymer elastomer is in a range from 300 to 1,000,000.

According to some preferred embodiments of the present invention, the block copolymer elastomer is a styrenic block copolymer elastomer.

According to some preferred embodiments of the present invention, the styrenic block copolymer elastomer is one or a plurality of copolymers selected from styrene-isoprene-styrene block copolymer (SIS), styrene-ethylene-propylene-styrene block copolymer (SEPS), styrene-butadiene-styrene block copolymer (SBS), styrene-ethylene-butene-styrene block copolymer (SEBS), styrene-isoprene-butadiene block copolymer (SIBS) and styrene-ethylene-ethylene-propylene-styrene block copolymer (SEEPS).

According to some preferred embodiments of the present invention, the fiber is one or a plurality of fibers selected from glass fiber, basalt fiber, ceramic fiber, carbon fiber and metal fiber.

According to some preferred embodiments of the present invention, the length of the inorganic fiber is in a range from 0.1 mm to 20 mm, and the diameter of the inorganic fiber is in a range from 5 μm to 30 μm.

According to some preferred embodiments of the present invention, the metal fiber is one or a plurality of fibers selected from lead fiber, nickel fiber, copper fiber, stainless steel fiber and aluminum fiber.

According to some preferred embodiments of the present invention, the elastic modulus of the thermoplastic non-elastomeric polymer is greater than 500 MPA.

According to some preferred embodiments of the present invention, the weight-average molecular weight of the thermoplastic non-elastomeric polymer is in a range from 1000 to 300,000.

According to some preferred embodiments of the present invention, the thermoplastic non-elastomeric polymer is one or a plurality of components selected from polystyrene (PS), polyethylene (PE), polylactic acid (PLA), polypropylene (PP), polymethyl methacrylate (PMMA), polyethylene glycol terephthalate (PET), polycarbonate (PC), polyvinyl chloride (PVC) and polyacrylic acid (PA).

According to some preferred embodiments of the present invention, the tackifier is one or a plurality of resins selected from terpene resin, rosin resin, C5 resin and C9 resin.

According to some preferred embodiments of the present invention, the weight-average molecular weight of the tackifier is in a range from 500 to 500,000.

According to some preferred embodiments of the present invention, the damping material further comprises 0.1-10 wt % of an antioxidant based on the total weight of the damping material.

According to some preferred embodiments of the present invention, the antioxidant is one or a plurality of antioxidants selected from pentaerythritol ester antioxidant and phosphite ester antioxidant.

According to some preferred embodiments of the present invention, the damping material further comprises 0.5-10 wt % of foaming agents based on the total weight of the damping material.

According to some preferred embodiments of the present invention, the foaming agent is one or a plurality of components selected from azodicarbonamide, sodium bicarbonate, CO₂, N₂, pentane, heptane, and bis (benzenesulfonyl hydrazide) ether.

According to some preferred embodiments of the present invention, the inorganic filler is an inorganic powder filler and is one or a plurality of components selected from talcum powder, mica, calcium carbonate, graphite, montmorillonite, wollastonite, silica, titanium dioxide, barium sulfate and aluminum hydroxide.

According to some preferred embodiments of the present invention, the flame retardant is one or a plurality of components selected from decabromodiphenyl ethane and antimony trioxide.

According to another aspect of the present invention, there is provided a damping sheet comprising a damping layer and a first pressure-sensitive adhesive layer stacked sequentially, wherein the damping layer comprises the damping material as described above.

According to some preferred embodiments of the present invention, the thickness of the damping layer is in a range from 0.5 mm to 8 mm.

According to some preferred embodiments of the present invention, the thickness of the first pressure-sensitive adhesive layer is in a range from 0.01 mm to 1 mm.

According to still another aspect of the present invention, there is provided a damping sheet comprising a first pressure-sensitive adhesive layer, a damping layer, a second pressure-sensitive adhesive layer and a constrained layer stacked sequentially, wherein the damping layer comprises the damping material as described above.

According to some preferred embodiments of the present invention, the constrained layer is a metallic layer.

According to some preferred embodiments of the present invention, the metallic layer is aluminum foil, iron foil, copper foil, nickel foil or titanium foil.

According to some preferred embodiments of the present invention, the thickness of the constrained layer is in a range from 0.05 mm to 1 mm.

According to some preferred embodiments of the present invention, the thickness of the damping layer is in a range from 0.5 mm to 8 mm.

According to some preferred embodiments of the present invention, the thickness of the first pressure-sensitive adhesive layer is in a range from 0.01 mm to 2 mm.

According to some preferred embodiments of the present invention, the thickness of the second pressure-sensitive adhesive layer is in a range from 0.01 mm to 2 mm.

Compared with the prior art, the present invention has the following beneficial effects:
1. The damping material has high damping properties and can replace conventional asphalt, butyl rubber, and other damping materials;
2. The damping material contains no cancerogenic polycyclic aromatic hydrocarbons, thereby making it extremely safe;
3. The damping material has a wide application temperature range (0-60° C.); and
4. The damping material has a low density and is more lightweight than the asphalt damping material, butyl rubber-based damping material, and LASD (liquid-applied sound damper) that are currently used.

### BRIEF DESCRIPTION OF THE DRAWINGS

FIG. 1 shows a transverse cross-sectional view of a free damping sheet according to one embodiment of the present invention; and

FIG. 2 shows a transverse cross-sectional view of a constrained damping sheet according to another embodiment of the present invention.

### DETAILED DESCRIPTION

The present invention will be further described in detail below in conjunction with the embodiments. It will be appreciated that other embodiments are considered, and can be practiced without departing from the scope and spirit of the present invention. Therefore, the following detailed description is non-limiting.

Unless otherwise indicated, all numbers expressing feature sizes, quantities and physiochemical properties used in the description and claims are to be understood as being modified by the term “about” in all cases. Therefore, unless stated conversely, parameters in numerical values listed in the above description and the appended claims are all approximate values, and those of skill in the art are capable of seeking to obtain desired properties by taking advantage of contents of the teachings disclosed herein, and changing these approximate values appropriately. The use of a numerical range represented by end points includes all numbers within the range and any range within the range, for example, 1 to 5 includes 1, 1.1, 1.3, 1.5, 2, 2.75, 3, 3.80, 4, 5, and the like.

According to the disclosure of the present invention, unless otherwise specified, the term “application temperature” refers to a temperature where the damping properties of the damping material do not undergo significant changes that cause the damping material to be unsuitable for actual application in damping, i.e., the loss coefficient of the damping material is not less than 0.1 in the range of the “application temperature”.

For the development of damping materials, it is very important to select the most optimal polymer system. The inventors of the present invention have found through experiments that the highest loss coefficient of the most commonly used asphalt product (having a thickness of 2.0 mm) was about 0.15. In addition, the glass transition temperature (Tg) and loss coefficient of ethylene-vinyl acetate (EVA) copolymer and polyolefin (POE) resin are too low to be designed as acceptable damping products applied at a temperature between 0° C. and 60° C. Additionally, although polyvinyl chloride (PVC) material exhibits better damping properties, the plasticizer inside it may leak over time and result in poor performance. Moreover, PVC has a foul smell and contains VOCs that cause problems; therefore PVC is not suitable for use as polymers in damping products.

The inventors of the present invention have found that block copolymer elastomer material with an elastic modulus of less than or equal to 500 MPa generally has the following: a high loss coefficient, an appropriate glass transition temperature (Tg), and the potential to be used for the preparation of damping products having excellent damping properties. However, the application temperature of the block copolymer elastomer material is generally low (less than 0° C.) and hampers application thereof in damping products. The inventors of the present invention have found that by adding a tackifier into the block copolymer elastomer material, the application temperature of the resulting damping material can be increased to room temperature, but at the same time, this change in temperature may adversely lead to the deterioration of damping properties, i.e., the loss coefficient is reduced. On the other hand, the inventors of the present invention have found that the loss coefficient can be increased to a certain extent when a thermoplastic non-elastomeric polymer (with a elastic modulus of greater than 500 MPa) is further added into the mixed system of the block copolymer elastomer material and the tackifier, but this procedure can still make the damping properties of the resulting damping material comparable to that of the asphalt damping material. Surprisingly, the inventors of the present invention have found that when a fiber and a thermoplastic non-elastomeric polymer are simultaneously added into the mixed system of the block copolymer elastomer material and the tackifier, the damping properties can be greatly improved, thereby obtaining a damping material having high damping properties, a wide application temperature range (0-60° C.), and a low density. Therefore, the technical solution according to the present invention achieves the following technical objective: simultaneously increasing the application temperature and retaining high damping properties through the synthesis among the block copolymer elastomer, the thermoplastic non-elastomeric polymer, the tackifier, and the fiber.

Specifically, according to one aspect of the present invention, there is provided a damping material comprising, based on the total weight thereof, the following:

10-50 wt % of a block copolymer elastomer;

5-40 wt % of fiber;

5-45 wt % of a thermoplastic non-elastomeric polymer;

5-50 wt % of a tackifier;

0-50 wt % of an inorganic filler; and

0-30 wt % of a flame retardant.

The elastic modulus of the block copolymer elastomer is less than or equal to 500 MPa, preferably in a range from 0.1 MPa to 20 MPa. The elastic modulus according to the present invention is determined according to the method ASTM-D 412.

The block copolymer elastomer has a high loss coefficient and an appropriate Tg and has the potential to be used for the preparation of damping products with excellent damping properties. The weight-average molecular weight of the block copolymer elastomer is in a range from 300 to 1,000,000, preferably from 500 to 50,000. Preferably, the block copolymer elastomer is a styrenic block copolymer elastomer, wherein the elastomer with optimized physical properties is obtained by adopting the process of copolymerizing a styrene block with other different blocks. Preferably, the styrenic block copolymer elastomer is one or a plurality of copolymers selected from styrene-isoprene-styrene block copolymer (SIS), styrene-ethylene-propylene-styrene block copolymer (SEPS), styrene-butadiene-styrene block copolymer (SBS), styrene-ethylene-butene-styrene block copolymer (SEBS), styrene-isoprene-butadiene block copolymer (SIBS), styrene-ethylene-ethylene-propylene-styrene block copolymer, and etc. According to the technical solution of the present invention, the damping material comprises 10-50 wt %, preferably 10-30 wt %, and more preferably 10-20 wt % of a block copolymer elastomer based on the total weight of the damping material. Commercially available block copolymer elastomer products that can be used in the present invention include: styrene-isoprene-styrene block copolymers (SIS) produced by Kraton (USA), batch no. D1161, D1113, D1164 and D1119; styrene-butadiene-styrene block copolymers (SBS) by Kraton (USA), batch no. D1101, D1152 and D1192; styrene-isoprene-butadiene block copolymers (SIBS) by Kraton (USA), batch no. D1170 and D1171; styrene-ethylene-butene-styrene block copolymers (SEBS) by Kraton (USA), batch no. G1657 and G1726; and styrene-ethylene-butene-styrene block copolymers (SEBS) by Kraton (USA), batch no. G01701 and G1730.

The damping material according to the present invention is added with a fiber. The function of the fiber is to improve the damping properties and balance the application temperature of the damping material along with the tackifier. The fiber is preferably an inorganic fiber. The fiber is one or a plurality of fibers selected from glass fiber, basalt fiber, ceramic fiber, carbon fiber, metal fiber, and etc. The length of the inorganic fiber is in a range from 0.1 mm to 20 mm, preferably from 1 mm to 5 mm, and the diameter is in a range from 5 μm to 30 μm, preferably from 8 μm to 15 μm. The metal fiber is one or a plurality of fibers selected from lead fiber, nickel fiber, copper fiber, stainless steel fiber, and aluminum fiber. The damping material comprises 5-40 wt %, preferably 10-40 wt %, and more preferably 20-30 wt % of the inorganic fiber based on the total weight of the damping material. Commercially available inorganic fiber products that can be used in the present invention include: glass fibers 988A and 306A produced by Jushi (Zhejiang, China) and carbon fibers T300 and T700 produced by Toray (Japan).

The damping material according to the present invention is added with a thermoplastic non-elastomeric polymer. The thermoplastic non-elastomeric polymer is used for increasing the modulus of the damping material and for increasing the application temperature to room temperature. The thermoplastic non-elastomeric polymer is non-elastic with an elastic modulus of greater than 500 MPa. The weight-average molecular weight of the thermoplastic non-elastomeric polymer is in a range from 1,000 to 300,000, preferably from 5,000 to 100,000. Preferably, the thermoplastic non-elastomeric polymer is selected from one or a plurality of the following: polystyrene (PS), polyethylene (PE), polylactic acid (PLA), polypropylene (PP), polymethyl methacrylate (PMMA), polyethylene glycol terephthalate (PET), polycarbonate (PC), polyvinyl chloride (PVC), polyacrylic acid (PA), and etc. According to the technical solution of the present invention, the damping material comprises 5-45 wt %, preferably 10-40 wt %, and more preferably 15-30 wt % of the thermoplastic non-elastomeric polymers based on the total weight of the damping material. Commercially available thermoplastic non-elastomeric polymer products that can be used in the present invention include: polystyrene resin PG 33 and PG 22 produced by CHiMei (Taiwan, China); polystyrene resin 1960N and 1810 by Total (France); polyethylene (PE) resin Dow 582e and 9530 by Dow; and polylactic acid (PLA) resin 3001D and 4032D by Nature Works (USA).

The damping material according to the present invention is added with a tackifier. As discussed later, the function of the tackifier is to improve the damping properties and balance the application temperature of the damping material along with the inorganic fiber. The tackifier isone or a plurality of resins selected from terpene resin, rosin resin, C5 resin, C9 resin, and etc. In addition, the weight-average molecular weight of the tackifier is in a range from 500 to 500,000. The damping material comprises 5-50 wt %, preferably 10-40 wt %, and more preferably 20-30 wt % of the tackifiers based on the total weight of the damping material. Commercially available tackifier products that can be used in the present invention include: terpene resin 803L produced by Arakawa Chemical (Japan); C5 resin C100 and 8095 by Eastman (USA); and C9 resin 290LV by Eastman (USA).

In addition to the above composition, the damping material according to the present invention may further comprise one or a plurality of other additives to impart the damping material with one or a plurality of desired physical or chemical properties, such as oxidation resistance, foaming properties, flame retardance, and mechanical properties. Specifically, the damping material further comprises 0.1-10 wt % of an antioxidant based on the total weight of the damping material. The antioxidant is one or a plurality of antioxidants selected from pentaerythritol ester antioxidant, phosphite ester antioxidant, and etc. Additionally, the damping material further comprises 0.5-10 wt % of foaming agents based on the total weight of the damping material. The foaming agent is one or a plurality of components selected from azodicarbonamide, sodium bicarbonate, CO₂, N₂, pentane, heptane, bis (benzenesulfonyl hydrazide) ether, and etc. Furthermore, the damping material further comprises 0-50 wt % of an inorganic filler based on the total weight of the damping material to improve the mechanical properties of the damping material. The inorganic filler is one or a plurality of components selected from talcum powder, mica, calcium carbonate, graphite, montmorillonite, wollastonite, silica, titanium dioxide, barium sulfate, aluminum hydroxide, and etc. Preferably, the damping material comprises 10-50 wt % of a block copolymer elastomer, 5-45 wt % of polyethylene, 5-50 wt % of a tackifier, and 5-40 wt % of inorganic fiber based on the total weight of the damping material; moreover, the damping material comprises an inorganic filler. In addition, optionally, the damping material further comprises 0-30 wt % of a flame retardant based on the total weight of the damping material. The flame retardant is one or a plurality of components selected from decabromodiphenyl ethane and antimony trioxide. Additional desired properties can be imparted to the damping material by adding the above additives in the damping material and appropriately adjusting their content.

There is no particular limitation on the method of preparing the above damping material; it can be prepared by performing mixing and extrusion using a twin screw extruder. Specifically, the temperatures of the twin screw extruder are set as a temperature gradient of 80° C.-140° C.-180° C.-180° C.-180° C.-180° C.-180° C.-180° C. from a hopper to a die. The materials (including block copolymer elastomer, thermoplastic non-elastomeric polymer, and tackifier) are first mixed in a bag and then added to the extruder to prepare a composite. The inorganic fiber is then introduced into an appropriate position of the screws to obtain a desired inorganic fiber length. The content of the inorganic fiber is controlled by the fiber number and the speed ratio of the main feed to the side feed.

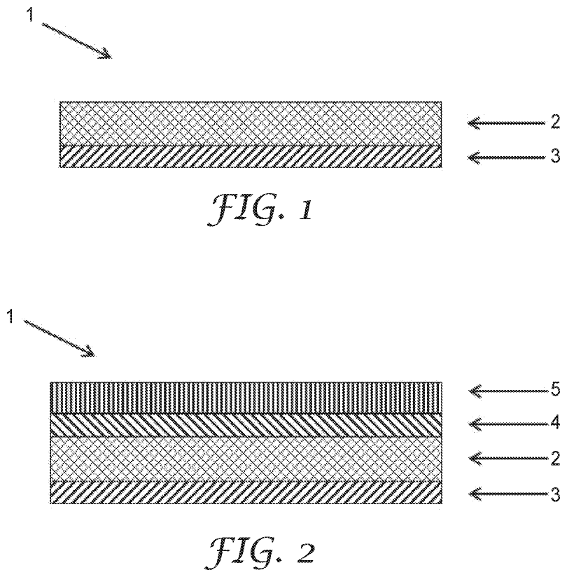

Another aspect of the present invention provides a damping sheet including a damping layer and a first pressure-sensitive adhesive layer stacked sequentially, wherein the damping layer comprises the damping material as described above. The damping sheet is a free damping sheet. FIG. 1 shows a transverse cross-sectional view of a damping sheet 1 according to one embodiment of the present invention. The damping sheet 1 includes a damping layer 2 and a first pressure-sensitive adhesive layer 3 stacked sequentially. The damping layer 2 comprises the damping material as described above, the damping material comprising 10-50 wt % of a block copolymer elastomer, 5-45 wt % of a thermoplastic non-elastomeric polymer, 5-50 wt % of a tackifier, 5-40 wt % of fiber, 0-50 wt % of an inorganic filler, and 0-30 wt % of a flame retardant. In order to achieve high damping effectiveness, the thickness of the damping layer 2 is controlled above 0.5 mm, preferably in a range from 0.5 mm to 8 mm, and more preferably from 0.5 mm to 2 mm. There is no particular limitation on the specific type of pressure-sensitive adhesive that can be used in the present invention in the first pressure-sensitive adhesive layer 3. The pressure-sensitive adhesive can be a commercially available pressure-sensitive material commonly used for damping materials in the art. The thickness of the first pressure-sensitive adhesive layer 3 is in a range from 0.01 mm to 1 mm.

In yet another aspect of the present invention, a damping sheet including a first pressure-sensitive adhesive layer, a damping layer, a second pressure-sensitive adhesive layer, and a constrained layer stacked sequentially is provided, wherein the damping layer comprises the damping material as described above. The damping sheet is a constrained damping sheet due to the presence of the constrained layer. FIG. 2 shows a transverse cross-sectional view of a damping sheet 1 according to another embodiment of the present invention. The damping sheet 1 includes a first pressure-sensitive adhesive layer 3, a damping layer 2, a second pressure-sensitive adhesive layer 4, and a constrained layer 5 stacked sequentially, wherein the damping layer 5 comprises the damping material as described above, the damping material comprising 10-50 wt % of styrenic elastomers, 5-45 wt % of a thermoplastic non-elastomeric polymer, 5-50 wt % of a tackifier, 5-40 wt % of fiber, 0-50 wt % of an inorganic filler, and 0-30 wt % of a flame retardant. According to the technical solution of the present invention, preferably, the constrained layer 2 is a metallic layer. The metallic layer is aluminum foil, iron foil, copper foil, nickel foil, or titanium foil. The thickness of the constrained layer 2 is in a range from 0.01 mm to 1 mm, preferably from 0.05 mm to 1 mm. In order to achieve high damping effectiveness, the thickness of the damping layer 2 is controlled above 0.5 mm, preferably in a range from 0.5 mm to 8 mm, and more preferably from 0.5 mm to 2 mm. In the present invention, there is no particular limitation on the specific types of pressure-sensitive adhesives that can be used in the first pressure-sensitive adhesive layer 3 and the second pressure-sensitive adhesive layer 4; they can be the same or different, and they can be commercially available pressure-sensitive materials commonly used for damping materials in the art.

There is no particular limitation on the method of preparing the above-described damping sheet with a stacked structure, which can be prepared, for example, by the co-extrusion method commonly employed in the art.

The present invention will be further described below in more detail in combination with examples. It needs to point out that, these descriptions and examples are all intended to make the invention easy to understand, rather than to limit the invention. The protection scope of the present invention is subject to the appended claims.

### Embodiments

In the present invention, unless otherwise pointed out, the reagents employed are all commercially available products, which are directly used without further purification. Furthermore, the “%” mentioned is “wt %”, and the “part” mentioned is “part by weight”.

### Embodiments

Damping material sheets with different compositions are prepared in Embodiments 1-10 and Comparative Examples 1-5 below.

### Embodiment 1

The following are mixed to obtain a thermoplastic resin mixture: 35 parts by weight of PS resin (polystyrene (PS) resin 1960N produced by Total in France); 14 parts by weight of SIS resin (styrene-isoprene-styrene block copolymers (SIS) produced by Kraton in USA, batch no. D1161); 21 parts by weight of C5 resin, 10 parts by weight of a flame retardant (comprising 7 parts by weight of decabromodiphenyl ethane and 3 parts by weight of antimony trioxide); 1 part by weight of azodicarbonamide as foaming agents (additives are not included in the total weight, accounting for 1% of the total amount of other materials); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, where the set temperatures of ten areas from a first hopper to a die are sequentially and respectively 80° C., 150° C., 190° C., 200° C., 200° C., 210° C., 210° C., 205° C., 205° C., and 205° C.

The prepared thermoplastic resin mixture is fed into the first hopper. The twin screw extruder is activated, and the premixture is subjected to melting, mixing, and extrusion under set conditions.

20 parts by weight of continuous glass fiber (glass fibers 988A produced by Jushi in Zhejiang, China) are fed in the form of bundles via the exhaust vent of the extruder. The continuous glass fiber and the thermoplastic resin mixture are mixed in the extruder, and the fiber is maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 2

The following are mixed to obtain a thermoplastic resin mixture: 5 parts by weight of PE resin (polyethylene (PE) resin DOW 582e produced by DOW); 16 parts by weight of SIS resin (styrene-isoprene-styrene block copolymers (SIS) produced by Kraton in USA, batch no. D1113); 25 parts by weight of CS resin, 4 parts by weight of a flame retardant (comprising 3 parts by weight of decabromodiphenyl ethane and 1 part by weight of antimony trioxide); 30 parts by weight of mica, 1.5 parts by weight of sodium bicarbonate foaming agents (additives are not included in the total weight, accounting for 1.5% of the total amount of other materials); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas (areas a-i) from a first hopper to a die are sequentially and respectively 80° C., 150° C., 190° C., 190° C., 190° C., 190° C., 190° C., 190° C., 180° C. and 180° C.

The prepared thermoplastic resin mixture is fed into the first hopper. The twin screw extruder is activated, and the premixture is subjected to melting, mixing, and extrusion under set conditions.

20 parts by weight of continuous glass fiber (glass fibers 988A produced by Jushi in Zhejiang, China) are fed in the form of bundles via the exhaust vent of the extruder. The continuous glass fiber and the thermoplastic resin mixture are mixed in the extruder, and the fiber is maintained at a length of 1 mm to 8 mm. The mixture containing the glass fiber is then extruded through the sheet die and cooled to set, to obtain a damping material sheet with a thickness of 2 mm; or the mixture containing the glass fiber is coextruded through the sheet die with pressure-sensitive adhesives from other extruder dies, to obtain a free damping sheet or a constrained damping sheet.

### Embodiment 3

The following are mixed to obtain a thermoplastic resin mixture: 25 parts by weight of PLA resin (polylactic acid (PLA) resin 4032D produced by Nature Works in USA); 25 parts by weight of SIS resin (styrene-isoprene-styrene block copolymers (SIS) produced by Kraton in USA, batch no. D1164); 25 parts by weight of C5 resin; 10 parts by weight of mica; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

15 parts by weight of continuous glass fiber (glass fibers 988A produced by Jushi in Zhejiang, China) are fed in the form of bundles via the exhaust vent of the extruder. The continuous glass fiber and the thermoplastic resin mixture are mixed in the extruder, and the fiber is maintained at a length of 1 mm to 8 mm.

1 part by weight of CO₂ (additives are not included in the total weight, accounting for 1 wt % of the total amount of other materials) is injected into the twin screw extruder at ½ of the twin screws to mix with the mixture containing the glass fibers. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 4

The following are mixed to obtain a thermoplastic resin mixture: 35 parts by weight of PS resin (polystyrene resin 1960N produced by Total in France); 10 parts by weight of SIS resin (styrene-isoprene-styrene block copolymers (SIS) produced by Kraton in USA, batch no. D1164); 4 parts by weight of SBS resin (styrene-butadiene-styrene block copolymers (SBS) produced by Kraton in USA, batch no. D1101); 21 parts by weight of terpene resin; 10 parts by weight of a flame retardant (comprising 7 parts by weight of decabromodiphenyl ethane and 3 parts by weight of antimony trioxide); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

20 parts by weight of continuous carbon fibers (carbon fibers T300 produced by Toray in Japan) are fed in the form of bundles via the exhaust vent of the extruder. The continuous carbon fibers and the thermoplastic resin mixture are mixed in the extruder, and the fibers are maintained at a length of 1 mm to 8 mm.

2 parts by weight of pentane (additives are not included in the total weight, accounting for 2% of the total amount of other materials) is injected into the twin screw extruder at ½ of the twin screws to mix with the mixture containing the carbon fibers, followed by extrusion foaming. The mixture containing the carbon fibers is then extruded through the sheet die and cooled to set, to obtain a damping material sheet with a thickness of 2 mm; or the mixture containing the carbon fibers is coextruded through the sheet die with pressure-sensitive adhesives from other extruder dies, to obtain a free damping sheet or a constrained damping sheet.

### Embodiment 5

The following are mixed to obtain a thermoplastic resin mixture: 25 parts by weight of PE resin (polyethylene (PE) resin Dow 582e produced by Dow); 16 parts by weight of SIS resin (styrene-isoprene-styrene block copolymers (SIS) produced by Kraton in USA, batch no. D1119); 15 parts by weight of C5 resin; 10 parts by weight of C9 resin; 4 parts by weight of a flame retardant (comprising 3 parts by weight of decabromodiphenyl ethane and 1 part by weight of antimony trioxide); 20 parts by weight of mica; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 190° C., 190° C., 190° C., 190° C., 190° C., 180° C. and 180° C.

The prepared thermoplastic resin mixture is fed into the first hopper. The twin screw extruder is activated, and the premixture is subjected to melting, mixing, and extrusion under set conditions.

10 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 6

The following are mixed to obtain a thermoplastic resin mixture: 10 parts by weight of PE resin (polyethylene (PE) resin Dow 582e produced by Dow); 20 parts by weight of SIS resin (styrene-isoprene-styrene block copolymers (SIS) produced by Kraton in USA, batch no. D1119); 20 parts by weight of C5 resin; 6 parts by weight of C9 resin; 4 parts by weight of a flame retardant (comprising 3 parts by weight of decabromodiphenyl ethane and 1 part by weight of antimony trioxide); and 0.3 part by weight of antioxidants (the weight ratio of antioxidant 1010 to antioxidant 168 is 2:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 130° C., 190° C., 190° C., 190° C., 190° C., 190° C., 190° C., 180° C. and 180° C.

The prepared thermoplastic resin mixture is fed into the first hopper. The twin screw extruder is activated, and the premixture is subjected to melting, mixing, and extrusion under set conditions.

40 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 7

The following are mixed to obtain a thermoplastic resin mixture: 20 parts by weight of resin (polystyrene (PS) resin PG-22 produced by CHiMei in Taiwan, China); 15 parts by weight of SIS resin (styrene-isoprene-styrene block copolymers (SIS) produced by Kraton in USA, batch no. D1161); 50 parts by weight of C5 resin; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

15 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 8

The following are mixed to obtain a thermoplastic resin mixture: 25 parts by weight of PS resin (polystyrene (PS) resin 1810 produced by Total in France); 15 parts by weight of SIS resin (styrene-isoprene-styrene block copolymers (SIS) produced by Kraton in USA, batch no. D1113); 21 parts by weight of C5 resin; 19 parts by weight of mica; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

20 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 9

The following are mixed to obtain a thermoplastic resin mixture: 15 parts by weight of PE resin (polyethylene (PE) resin Dow 582e produced by Dow); 30 parts by weight of SIS resin (styrene-isoprene-styrene block copolymers (SIS) produced by Kraton in USA, batch no. D1161); 30 parts by weight of C5 resin; 15 parts by weight of mica; and 0.3 part by weight of antioxidants (the weight ratio of antioxidant 1010 to antioxidant 168 is 2:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 190° C., 190° C., 190° C., 190° C., 190° C., 180° C. and 180° C.

The prepared thermoplastic resin mixture is fed into the first hopper. The twin screw extruder is activated, and the premixture is subjected to melting, mixing, and extrusion under set conditions.

10 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### Embodiment 10

The following are mixed to obtain a thermoplastic resin mixture: 25 parts by weight of PS resin (polystyrene resin PG-33 produced by CHiMei in Taiwan, China); 20 parts by weight of SIS resin (styrene-isoprene-styrene block copolymers (SIS) produced by Kraton in USA, batch no. D1113); 25 parts by weight of C5 resin; 20 parts by weight of talcum powder; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

10 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture containing the glass fibers is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### COMPARATIVE EXAMPLE 1

The following are mixed to obtain a thermoplastic resin mixture: 35 parts by weight of PS resin (polystyrene resin 1960N produced by Total in France); 14 parts by weight of SIS resin (styrene-isoprene-styrene block copolymers (SIS) produced by Kraton in USA, batch no. D1161); 21 parts by weight of C5 resin, 10 parts by weight of a flame retardant (comprising 7 parts by weight of decabromodiphenyl ethane and 7 parts by weight of antimony trioxide); 20 parts by weight of mica; 1 part by weight of azodicarbonamide as foaming agents (additives are not included in the total weight, accounting for 1% of the total amount of other materials); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting and mixing under set conditions. The mixture is then extruded through the sheet die and cooled to set, to obtain a damping material sheet with a thickness of 2 mm; or the mixture is coextruded through the sheet die with pressure-sensitive adhesives from other extruder dies, to obtain a free damping sheet or a constrained damping sheet.

### COMPARATIVE EXAMPLE 2

The following are mixed to obtain a thermoplastic resin mixture: 40 parts by weight of PS resin (polystyrene (PS) resin PG-22 produced by CHiMei in Taiwan, China); 30 parts by weight of C5 resin, 10 parts by weight of a flame retardant (comprising 7 parts by weight of decabromodiphenyl ethane and 7 parts by weight of antimony trioxide); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

20 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm.

1 part by weight of CO2 (additives are not included in the total weight, accounting for 1% of the total amount of other materials) is injected into the twin screw extruder at ½ of the twin screws to mix with the mixture containing the glass fibers. The mixture is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### COMPARATIVE EXAMPLE 3

The following are mixed to obtain a thermoplastic resin mixture: 50 parts by weight of PS resin (polystyrene (PS) resin PG-33 produced by CHiMei in Taiwan, China); 20 parts by weight of SIS resin (styrene-isoprene-styrene block copolymers (SIS) produced by Kraton in USA, batch no. D1113); 10 parts by weight of a flame retardant (comprising 7 parts by weight of decabromodiphenyl ethane and 7 parts by weight of antimony trioxide); 1.5 parts by weight of sodium bicarbonate foaming agents (additives are not included in the total weight, accounting for 1.5% of the total amount of other materials); and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions. 20 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### COMPARATIVE EXAMPLE 4

The following are mixed to obtain a thermoplastic resin mixture: 30 parts by weight of PS resin (polystyrene resin 1960N produced by Total in France); 3 parts by weight of SIS resin (styrene-isoprene-styrene block copolymers (SIS) produced by Kraton in USA, batch no. D1119); 15 parts by weight of C5 resin, 10 parts by weight of a flame retardant (comprising 7 parts by weight of decabromodiphenyl ethane and 7 parts by weight of antimony trioxide); 22 parts by weight of talcum powder; and 0.3 part by weight of antioxidants (the weight ratio of antioxidant 1010 to antioxidant 168 is 3:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

20 parts by weight of continuous glass fibers (glass fibers 988A produced by Jushi in Zhejiang, China) are fed in the form of bundles via the exhaust vent of the extruder. The continuous glass fibers and the thermoplastic resin mixture are mixed in the extruder, and the fibers are maintained at a length of 1 mm to 8 mm. The mixture is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

### COMPARATIVE EXAMPLE 5

The following are mixed to obtain a thermoplastic resin mixture: 35 parts by weight of PS resin (polystyrene (PS) resin PG-33 produced by CHiMei in Taiwan, China); 14 parts by weight of SIS resin (styrene-isoprene-styrene block copolymers (SIS) produced by Kraton in USA, batch no. D1161); 21 parts by weight of C5 resin; 10 parts by weight of a flame retardant (comprising 7 parts by weight of decabromodiphenyl ethane and 7 parts by weight of antimony trioxide); and 0.3 part by weight of antioxidants (the weight ratio of antioxidant 1010 to antioxidant 168 is 2:1, and additives are not included in the total weight, accounting for 0.3% of the total amount of other materials).

A twin screw extruder is preheated to set temperatures, wherein the set temperatures of ten areas from a first hopper to a die are sequentially and respectively 80° C., 150° C., 190° C., 200° C., 200° C., 210° C., 210° C., 205° C., 205° C. and 205° C.

The prepared thermoplastic resin mixture is fed into the first hopper. The twin screw extruder is activated, and the premixture is subjected to melting, mixing, and extrusion under set conditions.

20 parts by weight of glass fibers (glass fibers 988A produced by Jushi in Zhejiang, China) is added in the form of short fibers via a side feed. The short glass fibers and the thermoplastic resin mixture are mixed in the extruder, and the fibers are maintained at a length of 0.01 mm to 0.05 mm. The mixture is then extruded through the sheet die and cooled to set, to obtain a damping material sheet with a thickness of 2 mm; or the mixture containing the glass fibers is coextruded through the sheet die with pressure-sensitive adhesives from other extruder dies, to obtain a free damping sheet or a constrained damping sheet.

The specific steps of preparing the free damping sheets or constrained damping sheets in above Embodiments 1-10 and Comparative Examples 1-5 are described as follows.

### Preparation of Free Damping Sheets Sorresponding to Embodiments 1-10 and Comparative Examples 1-5

50 wt % of C5 resin C100 produced by Eastman in USA and 50 wt % of styrene-isoprene-styrene block copolymers (SIS) produced by Kraton in USA (batch no. D1161) are mixed in a twin screw extruder to obtain a pressure-sensitive adhesive. The press-sensitive adhesive is coextruded from the twin screw extruder along with the mixture from the last sheet die according to any of Embodiments 1-10 and Comparative Examples 1-5 to obtain the free damping sheet shown in FIG. 1, with the thickness of the damping layer 2 being 2 mm and the thickness of the first pressure-sensitive adhesive layer 3 being 0.1 mm.

### Preparation of Constrained Damping Sheets Corresponding to Embodiments 1-10 and Comparative Examples 1-5

50 wt % of C5 resin C100 produced by Kraton in USA and 50 wt % of styrene-isoprene-styrene block copolymers (SIS) produced by Kraton in USA (batch no. D1161) are mixed respectively in two twin screw extruders to obtain two pressure-sensitive adhesives. The two pressure-sensitive adhesives in the two twin screw extruders are coextruded respectively on both sides of the mixture from the last sheet die according to any of Embodiments 1-10 and Comparative Examples 1-5 to obtain a damping sheet with a first pressure-sensitive adhesive layer, a damping layer, and a second pressure-sensitive adhesive layer stacked sequentially. The damping sheet is then laminated with aluminum foil, where the second pressure-sensitive adhesive layer is in contact with the aluminum foil, so as to obtain the constrained damping sheet 1 shown in FIG. 2, the constrained damping sheet 1 including the first pressure-sensitive adhesive layer 3, the damping layer 2, the second pressure-sensitive adhesive layer 4, and the constrained layer 5 stacked sequentially, wherein the thickness of the first pressure-sensitive adhesive layer 3 is 0.10 mm, the thickness of the damping layer 2 is 2 mm, the thickness of the second pressure-sensitive adhesive layer is 0.1 mm, and the thickness of the aluminum foil is 0.1 mm.

### Performance Test

The free damping sheets and constrained damping sheets prepared above corresponding to Embodiments 1-10 and Comparative Examples 1-5 were tested for damping properties (including constrained damping properties and free dampening properties) using the damping test methods listed below. Results are shown in Table 1 below. Furthermore, the damping material sheets obtained in Embodiments 1-10 and Comparative Examples 1-5 were tested for application temperature ranges and densities by the methods listed below. Results are shown in Table 1 below.

### Damping Properties Test

According to ASTM E756, samples are tested for damping properties on a turntable measuring system (model: VOTSCH T4-340) used for vibrating beam testing (VBT). The samples were 2 mm in thickness, 12.5 mm in width, and 215 mm in length. Specifically, the samples of the free damping sheets and the constrained damping sheets prepared above corresponding to Embodiments 1-10 and Comparative Examples 1-5 were respectively adhered to steel bars with a thickness of 1 mm, a width of 12.5 mm, and a length of 241 mm. The strip to be tested was clamped vertically at one end, and bending vibration was subjected to excitation by a non-contact electromagnetic exciter located near the free end at an excitation frequency of 200 Hz. The response of the strip to various frequencies of excitation was measured by a properly positioned sensor, and the sensor detected the vibration amplitude of the tested strip. The damping property is expressed by a loss coefficient, and was considered qualified when the loss coefficient was not less than 0.1.

### Application Temperature Range Test

“Application temperature” refers to a temperature where the damping properties of the damping material do not undergo significant changes that cause the damping material to be unsuitable for actual application in damping, i.e., the loss coefficient of the damping material is not less than 0.1 in the range of the application temperature. The range of “application temperature” was determined by measuring the loss coefficient during changing ambient temperature.

### Density Measurement

Making the damping material lightweight according to the present invention was verified by measuring the density of the damping material. Density is obtained by a conventional measurement method in the art, i.e., density equals the value obtained by dividing the weight of the damping material by volume, the unit of density being g/cc.

For ease of comparison, the compositions of the damping materials prepared in Embodiments 1-10 and Comparative Examples 1-5 and the test results regarding damping properties, application temperature ranges, and densities are listed in Table 1 below.

TABLE 1
Compositions of Damping Materials Prepared in Embodiments 1-10 (E1-E10) and Comparative Examples 1-5
(C1-C5) and Test Results Regarding Damping Properties, Application Temperature Ranges, and Densities

| Composition (wt %) | | E1 | E2 | E3 | E4 | E5 | E6 | E7 | E8 | E9 | E10 | C1 | C2 | C3 | C4 | C5 |
|---|---|---|---|---|---|---|---|---|---|---|---|---|---|---|---|---|
| Thermoplastic | PS | 35 | | | 35 | | | 20 | 25 | | 25 | 35 | 40 | 50 | 30 | 35 |
| non-elastomeric | PE | | 5 | | | 25 | 10 | | | 15 | | | | | | |
| polymer | PLA | | | 25 | | | | | | | | | | | | |
| Styrenic | SIS | 14 | 16 | 25 | 10 | 16 | 20 | 15 | 15 | 30 | 20 | 14 | | 20 | 3 | 14 |
| elastomer | SBS | | | | 4 | | | | | | | | | | | |
| Tackifier | Terpene resin | | | | 21 | | | | | | | | | | | |
| | C9 resin | | | 25 | | 10 | 6 | | | | | | | | | |
| | C5 resin | 21 | 25 | | | 15 | 20 | 50 | 21 | 30 | 25 | 21 | 30 | | 15 | 21 |
| Inorganic | Glass fiber | 20 | 20 | 15 | | 10 | 40 | 15 | 20 | 10 | 10 | | 20 | 20 | 20 | 20 |
| fiber | Carbon fiber | | | | 20 | | | | | | | | | | | |
| Antioxidant | Antioxidant | 0.2 | 0.2 | 0.2 | 0.2 | 0.2 | 0.2 | 0.2 | 0.2 | 0.2 | 0.2 | 0.2 | 0.2 | 0.2 | | 0.2 |
| | 168 | | | | | | | | | | | | | | | |
| | Antioxidant | 0.1 | 0.1 | 0.1 | 0.1 | 0.1 | 0.1 | 0.1 | 0.1 | 0.1 | 0.1 | 0.1 | 0.1 | 0.1 | | 0.1 |
| | 1010 | | | | | | | | | | | | | | | |
| Flame | Decabromodiphenyl | 7 | 3 | | 7 | 3 | 3 | | | | | 7 | 7 | 7 | 7 | 7 |
| retardant | ethane | | | | | | | | | | | | | | | |
| | Antimony | 3 | 1 | | 3 | 1 | 1 | | | | | 3 | 3 | 3 | 3 | 3 |
| | trioxide | | | | | | | | | | | | | | | |
| Foaming | AC/sodium | 1 | 1.5 | 1 | 2 | | | | | | | 1 | 1 | 1.5 | | |
| agent | bicarbonate/ | | | | | | | | | | | | | | | |
| | CO₂/pentane | | | | | | | | | | | | | | | |
| Inorganic | Mica | | 30 | 10 | | 20 | | | 19 | 15 | | 20 | | | | |
| filler | Talcum powder | | | | | | | | | | 20 | | | | 22 | |

Performance test results

| | | | | | | | | | | | | | | | |
|---|---|---|---|---|---|---|---|---|---|---|---|---|---|---|---|
| Free damping property | 0.22 | 0.18 | 0.2 | 0.2 | 0.15 | 0.18 | 0.15 | 0.2 | 0.14 | 0.16 | 0.08 | 0.05 | 0.04 | 0.02 | 0.10 |
| (loss coefficient) | | | | | | | | | | | | | | | |
| Constrained damping | 0.42 | 0.45 | 0.33 | 0.32 | 0.36 | 0.38 | 0.32 | 0.41 | 0.34 | 0.32 | 0.25 | 0.15 | 0.21 | 0.14 | 0.28 |
| property | | | | | | | | | | | | | | | |
| (loss coefficient) | | | | | | | | | | | | | | | |
| Application temperature | 0-40 | 0-58 | 0-50 | 0-52 | 0-48 | 0-50 | 3-50 | 2-53 | 0-56 | 5-52 | 10-40 | 15-38 | 15-40 | 20-34 | 10-43 |
| range (° C.) | | | | | | | | | | | | | | | |
| Density (g/cc) | 0.87 | 1.1 | 0.98 | 0.91 | 1.08 | 1.29 | 1.08 | 1.39 | 1.18 | 1.14 | 1.02 | 0.82 | 0.91 | 1.46 | 1.14 |

It can be known from the above results of Embodiments 1-10 in Table 1 that the resulting damping material has excellent damping properties (the loss coefficient is at least 0.14) when block copolymer elastomer, thermoplastic non-elastomeric polymer, tackifier, and inorganic fiber are selected and their content is controlled within the scope of the present invention. Furthermore, the damping material obtained according to Embodiments 1-10 has a very wide application temperature range of from about 0° C. to 60° C. The damping material obtained according to Embodiments 1-10 has a density of at most 1.39 g/cc, thereby demonstrating its lightweight characteristic.

It can be known from the results of Comparative Example 1 that when the inorganic fiber according to the present invention is not present in the damping material, the damping properties are greatly reduced with the loss coefficients of free damping sheet and constrained damping sheet respectively decreased to 0.08 and 0.25; therefore, such damping material is not suitable for use in the automobile process.

It can be known from the results of Comparative Example 2 that when the block copolymer elastomer according to the present invention is not present in the damping material, the damping properties are greatly reduced with the loss coefficients of free damping sheet and constrained damping sheet respectively decreased to 0.05 and 0.15; therefore, such a damping material is not suitable for use in the automobile process.

It can be known from the results of Comparative Example 3 that when the tackifier according to the present invention is not present in the damping material, the damping properties are greatly reduced with the loss coefficients of free damping sheet and constrained damping sheet respectively decreased to 0.04 and 0.21; therefore, such a damping material is not suitable for use in the automobile process.

It can be known from the results of Comparative Example 4 that when the block copolymer elastomer according to the present invention is present in the damping material but the content of the block copolymer elastomer is too low (3 wt %), the damping properties are greatly reduced with the loss coefficients of free damping sheet and constrained damping sheet respectively decreased to 0.02 and 0.14; therefore, such a damping material is not suitable for use in the automobile process. Moreover, the damping material has a high density (1.46 g/cc).

It can be known from the results of Comparative Example 5 that when the inorganic fiber in the damping material is too short (0.01 mm to 0.05 mm), the inorganic fiber cannot function to enhance the damping properties, and the damping properties are greatly reduced with the loss coefficients of free damping sheet and constrained damping sheet respectively decreased to 0.01 and 0.28.

It can be known from the above results that the damping material and the damping sheet made therefrom according to the present invention have high damping properties, a wide application temperature range (0-60° C.) and a low density, thereby being capable of serving as a novel damping material in the current automobile, rail transit, construction, and electrical appliance industries.

It will be apparent to those skilled in the art that various modifications and variations can be made to the present disclosure without departing from the spirit and scope of the present disclosure. Thus, if these modifications and variations of the present disclosure fall within the scope of the claims of the present invention and its equivalent techniques, the present disclosure intends to include these modifications and variations.

1. A damping material comprising, based on the total weight thereof, the following:
10-50 wt % of a block copolymer elastomer;
5-40 wt % of fiber;
5-45 wt % of a thermoplastic non-elastomeric polymer;
5-50 wt % of a tackifier;
0-50 wt % of an inorganic filler; and
0-30 wt % of a flame retardant.

2. The damping material according to claim 1, wherein the elastic modulus of the block copolymer elastomer is less than or equal to 500 Mpa.

3. (canceled)

4. The damping material according to claim 1, wherein the block copolymer elastomer is a styrenic block copolymer elastomer, preferably one or a plurality of copolymers selected from styrene-isoprene-styrene block copolymer, styrene-ethylene-propylene-styrene block copolymer, styrene-butadiene-styrene block copolymer, styrene-ethylene-butene-styrene block copolymer, styrene-isoprene-butadiene block copolymer, and styrene-ethylene-ethylene-propylene-styrene block copolymer.

5. The damping material according to claim 1, wherein the fiber is one or a plurality of fibers selected from glass fiber, basalt fiber, ceramic fiber, carbon fiber, and metal fiber.

6. The damping material according to claim 1, wherein the length of the fiber is in a range from 0.1 mm to 20 mm, and the diameter of the fiber is in a range from 5 μm to 30 μm.

7. The damping material according to claim 5, wherein the metal fiber is one or a plurality of fibers selected from lead fiber, nickel fiber, copper fiber, stainless steel fiber, and aluminum fiber.

8. The damping material according to claim 1, wherein the elastic modulus of the thermoplastic non-elastomeric polymer is greater than 500 MPA.

9. The damping material according to claim 1, wherein the weight-average molecular weight of the thermoplastic non-elastomeric polymer is in a range from 1,000 to 300,000.

10. The damping material according to claim 1, wherein the thermoplastic non-elastomeric polymer one or a plurality of components selected from polystyrene, polyethylene, polylactic acid, polypropylene, polymethyl methacrylate, polyethylene glycol terephthalate, polycarbonate, polyvinyl chloride, and polyacrylic acid.

11. The damping material according to claim 1, wherein the tackifier is one or a plurality of resins selected from terpene resin, rosin resin, C5 resin, and C9 resin.

12. The damping material according to claim 1, wherein the weight-average molecular weight of the tackifier is in a range from 500 to 500,000.

13. The damping material according to claim 1, wherein the damping material further comprises 0.1-10 wt % of an antioxidant based on the total weight of the damping material, the antioxidant preferably being one or a plurality of antioxidants selected from pentaerythritol ester antioxidant and phosphite ester antioxidant.

14. The damping material according to claim 1, wherein the damping material further comprises 0.5-10 wt % of foaming agents based on the total weight of the damping material, the foaming agent preferably being one or a plurality of components selected from azodicarbonamide, sodium bicarbonate, CO₂, N₂, pentane, heptane and bis (benzenesulfonyl hydrazide) ether.

15. The damping material according to claim 1, wherein the inorganic filler is an inorganic powder filler and is one or a plurality of components selected from talcum powder, mica, calcium carbonate, graphite, montmorillonite, wollastonite, silica, titanium dioxide, barium sulfate and aluminum hydroxide.

16. The damping material according to claim 1, wherein the flame retardant is one or a plurality of components selected from decabromodiphenyl ethane and antimony trioxide.

17. A damping sheet comprising a damping layer and a first pressure-sensitive adhesive layer stacked sequentially, wherein the damping layer comprises the damping material according to claim 1.

18. The damping sheet according to claim 17, wherein the thickness of the damping layer is in a range from 0.5 mm to 8 mm.

19. The damping sheet according to claim 17, wherein the thickness of the first pressure-sensitive adhesive layer is in a range from 0.01 mm to 1 mm.

20. A damping sheet comprising a first pressure-sensitive adhesive layer, a damping layer, a second pressure-sensitive adhesive layer, and a constrained layer stacked sequentially, wherein the damping layer comprises the damping material claim 1.

21. The damping sheet according to claim 20, wherein the constrained layer is a metallic layer.

22.-25. (canceled)
